(19) United States
(12) Patent Application Publication
(10) Pub. No.: US 2012/0256052 A1
(43) Pub. Date: Oct. 11, 2012

(54) WINDOW RING FOR AN AIRCRAFT WINDOW AND METHOD FOR THE PRODUCTION OF SAME

(75) Inventors: Andreas BECKER, Oepfingen (DE); Joerg MAEDER, Gussenstadt (DE)

(73) Assignee: DIEHL AIRCABIN GMBH, Laupheim (DE)

(21) Appl. No.: 13/440,455

(22) Filed: Apr. 5, 2012

(30) Foreign Application Priority Data
Apr. 7, 2011 (DE) 10 2011 016306.9

(51) Int. Cl. B64C 1/14; B05D 3/00

(52) U.S. Cl. 244/129.3; 427/554

(57) ABSTRACT

The invention relates to a window ring for a window of an aircraft, wherein the window ring is substantially formed of a light-guiding substrate, comprises at least one light inlet region to couple light into the substrate, and at least one light exit region which is formed in such a way that light coupled into the substrate exits in it.

### FIELD OF THE INVENTION

The invention relates to a window ring for a window of an aircraft and to a method for producing the window ring.

### BACKGROUND OF THE INVENTION

Window rings of this type form an aircraft window surround. The window rings are goblet-like in cross-section and have an outer side turned towards the passengers and in inner side turned away from the passengers. A window ring of this type can be enhanced by corresponding illumination. Window ring backlights are known for this purpose. According to the prior art, milky substrates which are backlit are generally used for this.

### SUMMARY OF THE INVENTION

The problem is to achieve uniform illumination. This is generally achieved merely with a minimum distance between the light source and the surface to be illuminated, which in turn increases the dimensions of the window ring and thus leads to problems with regard to space during the installation process.

The object of the invention is to provide a window ring of the type mentioned at the outset which comprises an illumination which can be formed in the most versatile manner possible, yet is constructed in a simple manner and requires little space.

This object is achieved by the features of claim 1. Further advantageous embodiments of the invention are the subject of each of the dependent claims. These may be combined in any technically feasible manner. The description, in particular in conjunction with the drawings, additionally characterizes and details the invention.

The window ring for an aircraft window according to the invention is substantially formed of a light-guiding substrate. This light-guiding substrate may be a transparent plastics material. The window ring may comprise at least one light inlet region to couple light into the substrate. Furthermore, at least one light exit region is provided which is formed in such a way that light coupled into the substrate exits into it. The light exit region may be provided on the window ring at any position. The light can thus be coupled in at a position where sufficient clearance remains.

A key aspect of the invention is that the window ring or substrate thereof itself acts as an optical waveguide. The substrate is therefore formed as a light-guiding material which thus guides light within the window ring to desired light exit regions. Apart from a light source and corresponding electrical connections, no additional components are therefore required for installation of a window ring according to the invention.

In principle, light can thus be guided from at least one light inlet region to the desired light exit regions within the window ring. To achieve an advantageous colour effect, the substrate may be formed of a tinted plastics material. Alternatively, a coloured film may be provided at the light exit regions between the substrate and the light exit.

In accordance with the invention the design of the window ring is kept simple compared to the prior art, but the light-guiding material forms a selective illumination of specific regions of the window ring. The position of the light exit regions is thus independent of the position of the light source and also of the position of the light inlet regions. It is thus possible, by means of the window ring according to the invention, for both larger areas of the window ring and, alternatively, selectively determined areas to be illuminated, for example with logos, symbols or the like. The perceived quality of the window ring can thus be increased.

Owing to the use of the substrate as an optical waveguide, the window ring according to the invention is no larger in terms of nominal size than a conventional window ring which is not illuminated. The window ring can be produced in a simple and economical manner.

According to one embodiment of the invention the window ring is painted or coated, at least on the outer side of the window ring directed towards the window, and does not have any paint or coating in the light exit regions. The light exit region(s) can thus be defined and formed relatively easily since they are not painted and coated, in contrast to the remaining outer side of the window ring, and therefore light from the substrate of the window ring can exit in these light exit regions. These light exit regions can also be formed relatively easily by the design of the paint or coating, and therefore symbols, logos or the like are relatively easy to form. The remaining painted or coated regions of the window ring or of the outer side thereof do not appear illuminated.

In accordance with a further embodiment of the invention, the window ring is coated with a reflective material or paint on the inner side turned away from the window to further improve the illumination effect of the window ring. As a result, light is additionally reflected from this side of the substrate turned away from the window and is cast onto the outer side turned towards the window. The illumination effect on this side of the window ring, which is visible and on which the light exit regions are located, is thus improved.

According to a further embodiment of the invention, a peripheral light inlet region is provided on the inner side of the window ring, which is turned away from the window and is thus not visible from the outside. Such a peripheral light inlet region may advantageously be used to couple in said light at any desired location.

According to a further embodiment of the invention, it may also advantageously be used to provide an LED light strip, which is likewise peripheral, at the light inlet region, which light strip thus couples light into the light inlet region over the entire periphery of said peripheral light inlet region. Varicoloured LED lights may also be used.

For a method for producing a window ring according to the invention, the light-guiding substrate of the window ring is injection-moulded or thermoformed and is painted or coated, at least on the outer side directed towards the window. Furthermore, the light exit region(s) is/are produced by means of lasering, engraving or milling.

The substrate is thus relatively easy to produce in a conventional manner by injection moulding or thermoforming. The outer side turned towards the window may first be painted completely and then provided with light exit regions by lasering, engraving or milling.

### BRIEF DESCRIPTION OF THE DRAWINGS

Some embodiments will be described in greater detail hereinafter with reference to the drawings, in which:

FIG. 1 is a schematic view of a side cladding with an aircraft window which is equipped with a window ring according to the invention;

FIG. 2 shows an aircraft window with a window ring according to the invention which comprises illuminated symbols;

FIG. 3 is a schematic side view of a cross-section through an aircraft window; and

FIG. 4 is a detailed view of an area from FIG. 3.

### DETAILED DESCRIPTION OF EXEMPLARY EMBODIMENTS

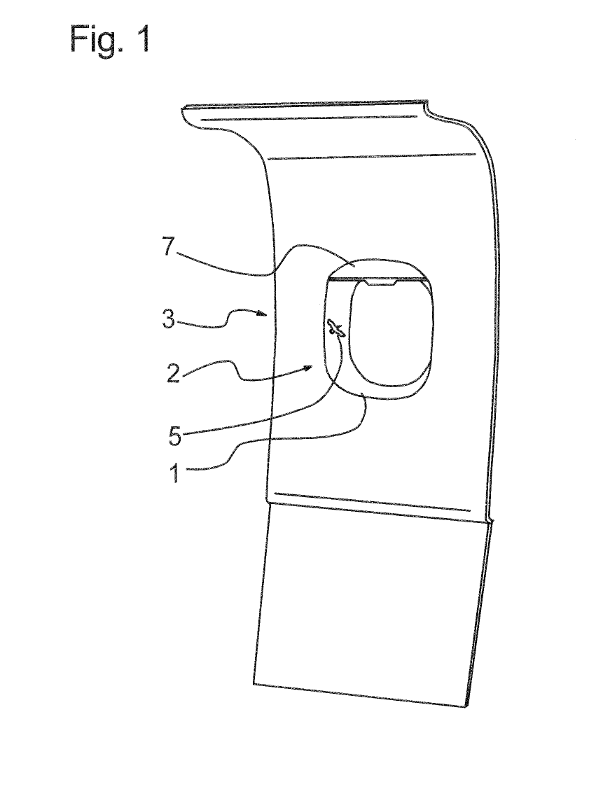

FIG. 1 shows a schematic view of a side cladding 3. The side cladding 3 comprises a window 2 with a window ring 1. Such side claddings 3 are used strung together in an aircraft (not shown) to provide cladding. A window ring according to the invention is provided which surrounds or borders an aircraft window 2.

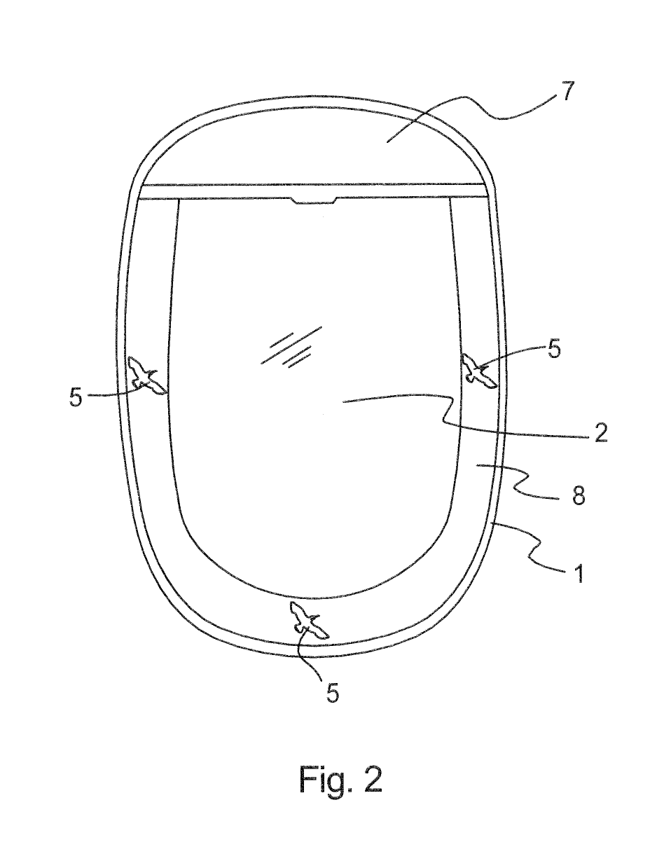

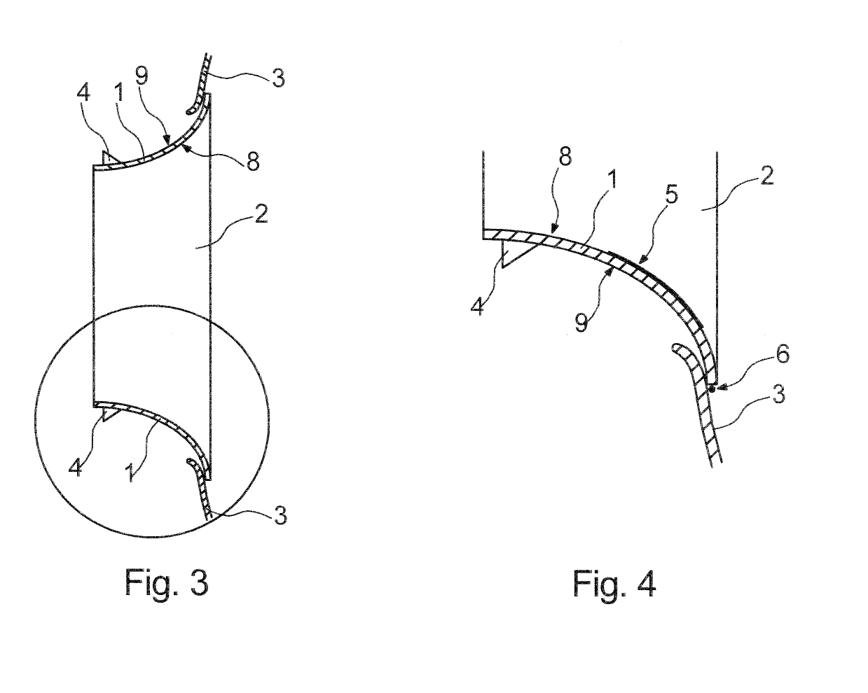

FIG. 2 shows an aircraft window 2 with the window ring 1 of FIG. 1 according to the invention viewed from the inside of the aircraft. A blind 7 is provided at the upper edge of the window 2. A side of the window ring 1 turned towards the interior of the aircraft or towards the window 2 is referred to as the outer side 8. An inner side 9 (see FIG. 3) points towards an outer shell of the aircraft in the assembled state and is therefore not visible either from the inside of the aircraft or from the outside.

The aircraft window 2 is framed by the window ring according to the invention and comprises light exit regions 5, which are provided on the outer side 8 of the main body 1.

In the example according to FIG. 2, three such light exit regions 5 are provided over the periphery of the window ring 1. These light exit regions 5 may be formed for example as symbols, logos of an aviation company or the like.

FIG. 3 shows a window ring 1 in cross-section, the inner side 9 of which, turned away from the window 2, comprises a light inlet region 4 which extends over the entire periphery of the window ring 1 (not directly visible from FIG. 3).

For example, an LED strip which likewise extends around the periphery may be provided at this light inlet region 4. This LED strip may possibly also radiate varicoloured light.

According to the invention the outer side 8 of the window ring 1, which is turned towards the window 2 and is visible from the inside of the aircraft, comprises one or more light exit regions 5 which are formed in such a way that light coupled into the light inlet region 4 is guided to light exit regions 5. For this purpose, the main body of the window ring 1 is formed of a light-guiding material which thus guides the light from the light inlet region 4 to the light exit regions 5.

This is shown in greater detail in FIG. 4 in a detailed view. The detailed view shows part of the window 2 and a detail of the window ring 1 according to the invention with the light inlet region 4. Similarly to FIG. 3, the window 1 is used in a side cladding 3 of an aircraft (not shown otherwise).

In the illustration according to FIG. 4, the main body of the window ring 1 is provided with a light exit region 5 approximately in a central region of its outer side 8, which is turned towards the aircraft window 2 and is visible from the outside. A further light exit 6 is also provided on the main body 1 at that end of the window ring 1 which overlaps the side cladding 3 of the aircraft. The light exit 6 may be formed as a ring-shaped surround completely surrounding the window 2 and visually demarcating the window 2 and window ring from the side wall 3.

The light exit regions 5 and 6 are not provided in the region of illumination, rather the light from the light inlet region 4 reaches the light exit regions 5 and 6 via the window ring 1 formed in light-guiding material.

To further improve the illumination effect, the window ring 1 may be coated on its inner side 9, which is turned away from the window 2, with a light-reflecting material (with the exception of the light inlet region 4) so that yet more light is cast onto the outer side 8 with the light exit regions. Furthermore, the window ring 1 may consist of a tinted plastics material so that the logos appear in colour.

The window ring according to the invention thus affords an illumination of the surround of an aircraft window, which illumination is relatively easy to form and is nevertheless effective. It requires little, or even no additional space compared to solutions according to the prior art which are not illuminated, and is simple to produce. The illuminations can be produced at any location and in any form by milling out, engraving or lasering the desired light exit regions.

### LIST OF REFERENCE NUMERALS

1 window ring substrate
2 aircraft window
3 aircraft side cladding
4 light inlet region
5 light exit regions
6 light exit region
7 aircraft window blind
8 outer side window ring
9 inner side window ring

1. A window ring for a window of an aircraft, wherein the window ring is substantially formed of a light-guiding substrate, comprising at least one light inlet region to couple light into the substrate, and at least one light exit region which is formed in such a way that light coupled into the substrate exits in it.

2. The window ring according to claim 1, wherein the window ring is painted or coated, at least on the outer side directed towards the window, and in that the light exit region comprises no paint or coating.

3. The window ring according to claim 1, wherein the light exit region(s) is/are formed as lettering, logos, symbols or the like.

4. The window ring according to claim 1 wherein a peripheral light inlet region is provided on the inner side of the window ring turned away from the window.

5. The window ring according to claim 1, wherein the window ring is coated with a reflective material or paint on the inner side turned away from the window.

6. The window ring according to claim 4, wherein an LED light strip, which is likewise peripheral, is provided on the peripheral light inlet region.

7. A method for producing a window ring according to claim 1 comprising injection moulding or thermoforming the light-guiding substrate of the window ring, painting or coating, at least on the outer side directed towards the window, and producing the light exit region(s) by means of lasering, engraving or milling.

8. The method according to claim 7, wherein a peripheral light inlet region is produced on the inner side of the substrate turned away from the window when said substrate is injection-moulded or thermoformed.

9. The method according to claim 7, wherein the window ring is additionally coated with a reflective material or paint on the inner side turned away from the window.

10. An aircraft window comprising a window ring according to claim 1.

11. An aircraft with windows which comprise window rings according to claim 1.
